(19) United States
(12) Patent Application Publication
(10) Pub. No.: US 2018/0227113 A1
(43) Pub. Date: Aug. 9, 2018

(54) RADIO APPARATUS AND METHOD FOR TIMING CONTROL

(71) Applicant: FUJITSU LIMITED, Kawasaki-shi (JP)

(72) Inventors: Ryosuke Kobayashi, Kawasaki (JP); Shinichiro Kobayashi, Yokohama (JP)

(73) Assignee: FUJITSU LIMITED, Kawasaki-shi (JP)

(21) Appl. No.: 15/886,946

(22) Filed: Feb. 2, 2018

(30) Foreign Application Priority Data
Feb. 6, 2017 (JP) 2017-019498

(51) Int. Cl. H04L 5/22; H04B 1/44; H04W 52/02; H04B 1/3805

(52) U.S. Cl. CPC H04L 5/22; H04B 1/3805; H04W 52/02; H04B 1/44

(57) ABSTRACT

A radio apparatus includes: a processor configured to execute a processing to specify, based on one or more of relation information indicating relation among a time interval between timings of turning on or off a plurality of transmission circuits and a deterioration amount in signal quality value in the plurality of transmission circuits and power consumption of the radio apparatus, a first time interval that causes the power consumption to be minimum, the first time interval being one of the time intervals included in the relation information that correspond to calculated deterioration amount that causes a signal quality value of a transmission signal to be in a range of a standard value or less, and a processing to shift timing of turning on or off at least one of the plurality of transmission circuit, based on the first time interval.

### CROSS-REFERENCE TO RELATED APPLICATION

This application is based upon and claims the benefit of priority of the prior Japanese Patent Application No. 2017-019498, filed on Feb. 6, 2017, the entire contents of which are incorporated herein by reference.

### FIELD

The embodiment discussed herein is related to a radio apparatus and a method for timing control.

### BACKGROUND

In recent years, in order to increase network capacity, a communication using a plurality of antennas has been considered. In many cases, in a radio apparatus that performs a communication using a plurality of antennas, a transmission circuit and a reception circuit that correspond to each antenna are mounted.

Incidentally, for example, in a radio apparatus that is operated in a time division duplex (TDD) system, it is in general to turn on or off a transmission circuit and a reception circuit that correspond to each antenna at the same time in a gap section in which a signal is not transmitted or received. When the transmission circuit and the reception circuit that correspond to each antenna are turned on or off, a power source voltage that is applied to the transmission circuit and the reception circuit transiently varies, and therefore, a signal quality value, such as an error vector magnitude (EVM) or the like, does not satisfy a standard value and transmission quality and reception quality are deteriorated. Therefore, it has been examined to reduce a range of transient variation of the power source voltage by shifting timing of turning on the reception circuit that corresponds to each antenna and thus to reduce deterioration in reception quality.

Examples of the related art include Japanese Laid-open Patent Publication No. 2009-135623.

### SUMMARY

According to an aspect of the invention, a radio apparatus for a radio communication using a plurality of antennas includes: a first transmission circuit configured to output a first transmission signal to be transmitted from a first antenna; a second transmission circuit configured to output a second transmission signal to be transmitted from a second antenna; a memory configured to store one or more of first correspondence relation information that indicates a first correspondence relation among a transmission time interval between timing of turning on or off the first transmission circuit and timing of turning on or off the second transmission circuit, a deterioration amount in signal quality value in the first transmission circuit or the second transmission circuit, and power consumption of the radio apparatus; and a processor configured to execute first measurement processing that includes measuring a signal quality value of a transmission signal to be transmitted from the first antenna or the second antenna, execute first control processing that includes a processing 1-1 configured to calculate a deterioration amount that causes the signal quality value of the transmission signal to be in a range of a standard value or less, a processing 1-2 configured to specify, in accordance with the one or more of the first correspondence relation information, a first time interval that causes the power consumption to be minimum, the first time interval being one of the transmission time intervals included in the first correspondence relation information that correspond to the deterioration amounts calculated by the processing 1-1, and a processing 1-3 configured to shift timing of turning on or off the first transmission circuit, in accordance with the first time interval specified by the processing 1-2.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a base station apparatus according to an embodiment;

FIG. 2 is a graph illustrating an example of EVM conversion information;

FIG. 3 is a chart illustrating envelopes for each modulation system;

FIG. 4 is a graph illustrating an example of a time interval DB;

FIG. 5 is a graph illustrating another example of the time interval DB;

FIG. 6 is a table illustrating an example of a standard value DB;

FIG. 7 is a chart illustrating a first specific example of switching on or off transmission circuits;

FIG. 8 is a chart illustrating the first specific example of switching on or off transmission circuits;

FIG. 9 is a chart illustrating a second specific example of switching on or off transmission circuits;

FIG. 10 is a chart illustrating the second specific example of switching on or off transmission circuits;

FIG. 11 is a flowchart illustrating an example of a processing operation of an RE device according to an embodiment; and

FIG. 12 is a diagram illustrating a hardware configuration example of the RE device.

### DESCRIPTION OF EMBODIMENT

In the above-described related art, it is not taken into consideration to reduce increase in power consumption while reducing deterioration in transmission quality.

That is, in the related art, timing of turning on the transmission circuit that corresponds to each antennal is synchronized, and therefore, there is a probability that, for the transmission signal, a signal quality value, such as EVM or the like, does not satisfies a standard value and, as a result, transmission quality is deteriorated.

To cope with this, it is an option to reduce deterioration in transmission quality by shifting timing of turning on the transmission circuit that corresponds to each antenna. However, when timing of turning on the transmission circuit that corresponds to each antenna is merely shifted, power consumption in the radio apparatus might increase depending on a time interval between the transmission circuits.

According to an aspect of the following embodiment, a technology in which, while reducing deterioration in transmission quality, increase in power consumption is reduced.

An embodiment of a radio apparatus and a timing control method disclosed herein will be described in detail below with reference to the accompanying drawings. Note that the technology disclosed herein is not limited to the embodiment.

### Embodiment

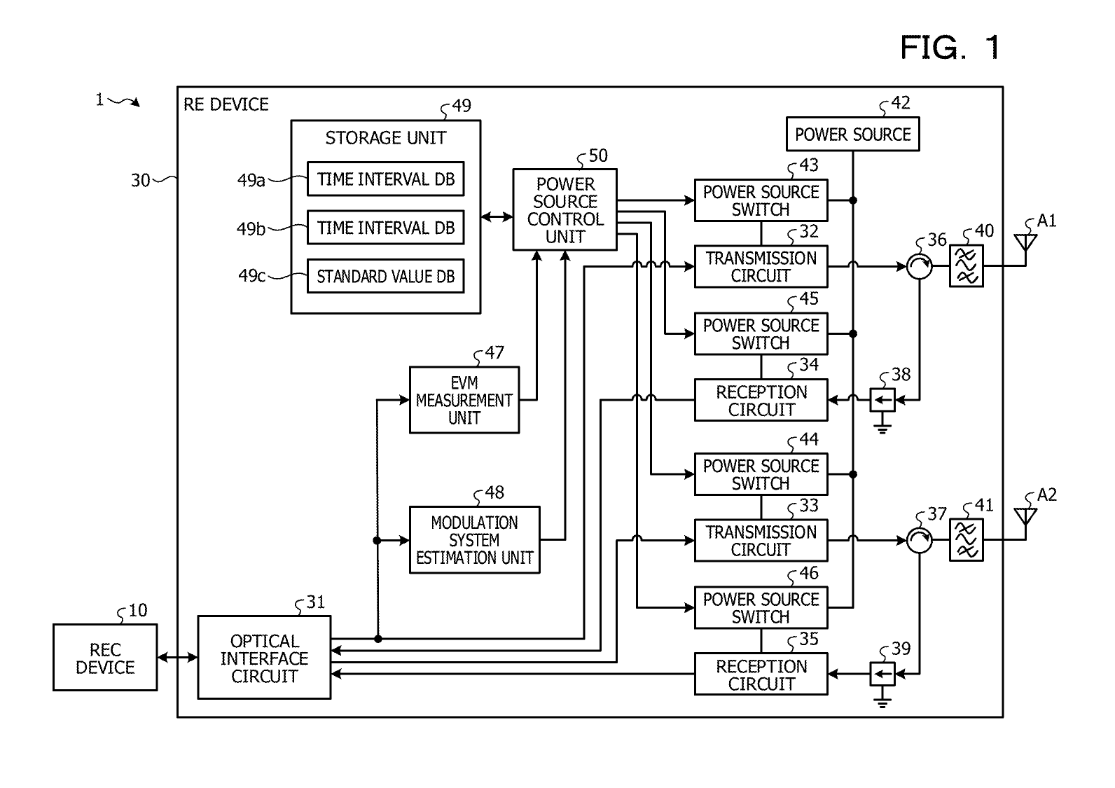

FIG. 1 is a block diagram illustrating an example of a base station apparatus 1 according to this embodiment. The base station apparatus 1 illustrated in FIG. 1 includes a radio equipment control (REC) device 10 and a radio equipment (RE) device 30. The RE device 30 is an example of a radio apparatus. The REC device 10 and the RE device 30 are coupled to one another via an optical transmission line based on, for example, a common public radio interface (CPRI) standard. Also, a time division duplex (TDD) system in which a transmission section and a reception section are temporally divided from one another is applied to the REC device 10 and the RE device 30. Note that, although, in the following description, in order to simplify the description, it is assumed that the number of antennas of the RE device 30 is two, the number of antennas is not limited to two.

The REC device 10 executes baseband processing, such as coding, modulation, or the like, on transmission data, to generate a transmission signal. In this case, it is assumed that, as the transmission signal, there are a transmission signal (which will be hereinafter referred to as a “first transmission signal”, as appropriate) which is transmitted from an antenna A1 of the RE device 30 and a transmission signal (which will be hereinafter referred to as a “second transmission signal”, as appropriate) which is transmitted from an antenna A2. The REC device 10 maps the first transmission signal and the second transmission signal that have been generated on the same optical communication frame (for example, a CPRI frame) and transmits the first transmission signal and the second transmission to the RE device 30 via the optical transmission line.

Also, the REC device 10 receives an optical communication frame that has been transmitted from the RE device 30 and executes baseband processing, such as demodulation, decoding, or the like, on a reception signal included in the received optical communication frame to acquire reception data. In this case, it is assumed that, as the reception signal, there are a reception signal (which will be herein after referred to as a “first reception signal”, as appropriate) which is received from the antenna A1 of the RE device 30 and a reception signal (which will be herein after referred to as a “second reception signal”, as appropriate) which is received from the antenna A2.

The RE device 30 performs transmission processing on the first transmission signal and the second transmission signal that have been transmitted from the REC device 10 and transmits the first transmission signal and the second transmission signal of a radio frequency, which have been acquired, to the antenna A1 and the antenna A2, respectively. Also, the RE device 30 performs reception processing on the first reception signal and the second reception signal that have been received via the antenna A1 and the antenna A2, respectively, and transmits the first reception signal and the second reception signal of a baseband, which have been acquired, to the REC device 10. Furthermore, the RE device 30 controls timing of turning on or off the transmission circuit that corresponds to each antenna (that is, the antenna A1 or the antenna A2) of the RE device 30 and controls timing of turning on or off the reception circuit that corresponds to each antennal.

Specifically, the RE device 30 includes an optical interface circuit 31, transmission circuits 32 and 33, reception circuits 34 and 35, circulators 36 and 37, isolators 38 and 39, and filters 40 and 41. The transmission circuit 32, the reception circuit 34, the circulator 36, the isolator 38, and the filter 40 correspond to a single antenna A1 and the transmission circuit 33, the reception circuit 35, the circulator 37, the isolator 39, and the filter 41 correspond to another single antenna A2. Also, the RE device 30 includes a power source 42 and power source switches 43, 44, 45, and 46. The RE device 30 includes an EVM measurement unit 47, a modulation system estimation unit 48, a storage unit 49, and a power source control unit 50.

The optical interface circuit 31 receives the optical communication frame that has been transmitted from the RE device 30 and extracts the first transmission signal and the second transmission signal that are included in the optical communication frame that has been received. The optical interface circuit 31 outputs the first transmission signal that has been extracted to the transmission circuit 32 and outputs the second transmission signal that has been extracted to the transmission circuit 33. Also, the optical interface circuit 31 maps the first reception signal and the second reception signal that are output from the reception circuits 34 and 35 on the optical communication frame (for example, the CPRI frame) and transmits the first reception signal and the second reception signal to the RE device 30 via the optical transmission line.

The transmission circuit 32 is coupled to the power source 42 via the power source switch 43 and a power source voltage is applied to the transmission circuit 32 via the power source switch 43. The transmission circuit 32 receives the first transmission signal that has been output from the optical interface circuit 31. Then, the transmission circuit 32 performs transmission processing (digital-analog (DA) conversion, up-conversion, amplification, or the like) on the first transmission signal using the power source voltage that is applied thereto and outputs the first transmission signal of a radio frequency, which has been acquired, to the circulator 36. The transmission circuit 32 is an example of a first transmission circuit. Also, the transmission circuit 33 is coupled to the power source 42 via the power source switch 44 and a power source voltage is applied to the transmission circuit 33 via the power source switch 44. The transmission circuit 33 receives the second transmission signal that has been output from the optical interface circuit 31. Then, the transmission circuit 33 performs transmission processing (digital-analog (DA) conversion, up-conversion, amplification, or the like) on the second transmission signal and outputs the second transmission signal of a radio frequency, which has been achieved, to the circulator 37. The transmission circuit 33 is an example of a second transmission circuit.

The reception circuit 34 is coupled to the power source 42 via the power source switch 45 and a power source voltage is applied to the reception circuit 34 via the power source switch 45. The reception circuit 34 receives the first reception signal of a radio frequency, which is output from the isolator 38. Then, the reception circuit 34 performs reception processing (amplification, down-conversion, analog-digital (AD) conversion) on the first reception signal using a power source voltage that is applied thereto and outputs the first reception signal of a baseband, which has been achieved, to the optical interface circuit 31. Also, the reception circuit 35 is coupled to the power source 42 via the power source switch 46 and the power source voltage is applied thereto via the power source switch 46. The reception circuit 35 receives the second reception signal of a radio frequency, which is output from the isolator 38. Then, the reception circuit 35 performs reception processing (amplification, down-conversion, and analog-digital (AD) conversion) on the second reception signal using the power source voltage that is applied thereto and outputs the second reception signal of a baseband, which has been achieved, to the optical interface circuit 31.

Each of the circulators 36 and 37 includes at least three ports and outputs a signal that has been input from one of the ports to the next port. That is, the circulators 36 and 37 output the first transmission signal and the second transmission signal that are output from the transmission circuits 32 and 33 to antennas A1 and A2 sides, respectively. Also, the circulators 36 and 37 output the first reception signal and the second reception signal that have been received via the antennas A1 and A2 to reception circuits 34 and 35 sides, respectively.

The isolators 38 and 39 receive the first reception signal and the second reception signal that have been output from the circulators 36 and 37 to the reception circuits 34 and 35 sides. The isolators 38 and 39 remove reflected waves of the first transmission signal and the second transmission signal, which have been reflected by the antennas A1 and A2, from the first reception signal and the second reception signal and output the first reception signal and the second reception signal from which the reflected waves have been removed to the reception circuits 34 and 35.

The filters 40 and 41 perform filter processing on the first transmission signal and the second transmission signal that have been output from the circulators 36 and 37 to the antenna A1 and A2 sides and transmit the first transmission signal and the second transmission signal on which filter processing has been performed via the antennas A1 and A2. Also, the filters 40 and 41 perform filter processing on the first reception signal and the second reception signal that have been received via the antennas A1 and A2 and output the first reception signal and the second reception signal on which filter processing has been performed to the circulators 36 and 37.

The power source 42 supplies a power source voltage to the transmission circuits 32 and 33 and the reception circuits 34 and 35 via the power source switches 43, 44, 45, and 46.

The power source switches 43, 44, 45, and 46 switch on or off each of the transmission circuits 32 and 33 and the reception circuits 34 and 35 by electrically coupling or disconnecting the power source 42 and each of the transmission circuits 32 and 33 and the reception circuits 34 and 35 in accordance with control by the power source control unit 50. For example, when the power source switch 43 receives a switching signal that turns on the transmission circuit 32 from the power source control unit 50, the power source switch 43 electrically couples the power source 42 and the transmission circuit 32 to one another and switches on the transmission circuit 32. Also, for example, when the power source switch 43 receives a switching signal that turns off the transmission circuit 32 from the power source control unit 50, the power source switch 43 electrically disconnects the power source 42 and the transmission circuit 32 from one another and switches off the transmission circuit 32.

The EVM measurement unit 47 measures EVM, which is a signal quality value of a transmission signal (that is, the first transmission signal or the second transmission signal) which is transmitted from the antenna A1 or the antenna A2. For example, the EVM measurement unit 47 holds EVM conversion information that indicates a correspondence relation between electric power and EVM of the first transmission signal in advance, measures the electric power of the first transmission signal, and measures EVM of the first transmission signal using the electric power of the first transmission signal, which has been measured, and the EVM conversion information.

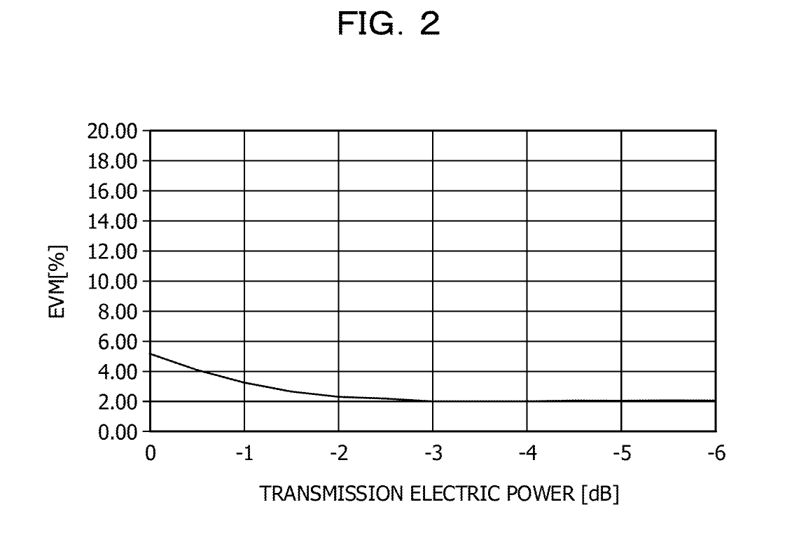

FIG. 2 is a graph illustrating an example of EVM conversion information. In FIG. 2, an abscissa indicates transmission electric power [dB] which is electric power of the first transmission signal and an ordinate indicates EVM [%]. For example, when the electric power of the first transmission signal is 0 dB, which is a maximum value, EVM of the first transmission signal, which is measured by the EVM measurement unit 47, is 5%.

Also, the EVM measurement unit 47 measures EVM which is a signal quality value of a reception signal (that is, the first reception signal or the second reception signal) which is received from the antenna A1 or the antenna A2. For example, the EVM measurement unit 47 measures EVM of the first reception signal by acquiring information that indicates EVM of the first reception signal from a host device, such as the REC device 10 or the like.

The modulation system estimation unit 48 estimates a modulation system of a transmission signal (that is, the first transmission signal or the second transmission) which is transmitted from the antenna A1 or the antenna A2 or a reception signal (that is, the first reception signal or the second reception signal) which is received from the antenna A1 or the antenna A2. For example, the modulation system estimation unit 48 acquires an envelope that indicates an amplitude waveform of the first transmission signal and estimates a modulation system of the first transmission signal using the envelope of the first transmission signal, which has been acquired.

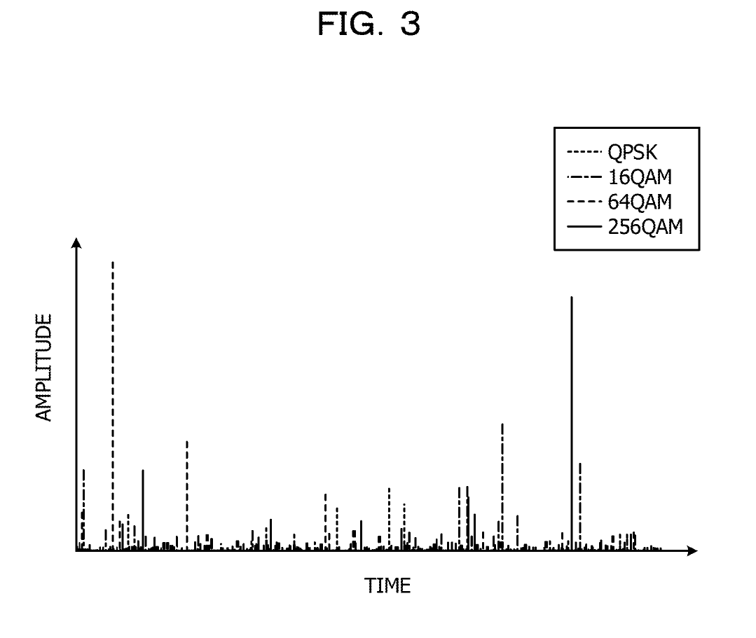

A change amount per unit time of the envelope (that is, the amplitude waveform) of the first transmission signal differs in accordance with the modulation system, as illustrated in FIG. 3. FIG. 3 is a chart illustrating envelopes for each modulation system. For example, the change amount per unit time of the envelope of the first transmission signal increases as a modulation multilevel number of the modulation system increases. In the example of FIG. 3, the change amount per unit time of the envelope of the first transmission signal increases in the order of quadrature phase shift keying (QPSK), 16 quadrature amplitude modulation (16QAM), 64QAM, and 256QAM. Therefore, the modulation system estimation unit 48 estimates the modulation system of the first transmission signal by analyzing the change amount per unit time of the envelope of the first transmission signal.

The storage unit 49 stores various types of information that is used for processing that is executed by the power source control unit 50. Specifically, the storage unit 49 includes a time interval DB 49a, a time interval DB 49b, and a standard value DB 39c.

The time interval DB 49a is a database configured to store a time interval between timing of turning on or off the transmission circuit 32 and timing of turning on or off the transmission circuit 33, a deterioration amount of EVM in the transmission circuit 32 or the transmission circuit 33, and information (which may be referred to as first correspondence relation information) which indicates a correspondence relation between the RE device 30 and the power consumption.

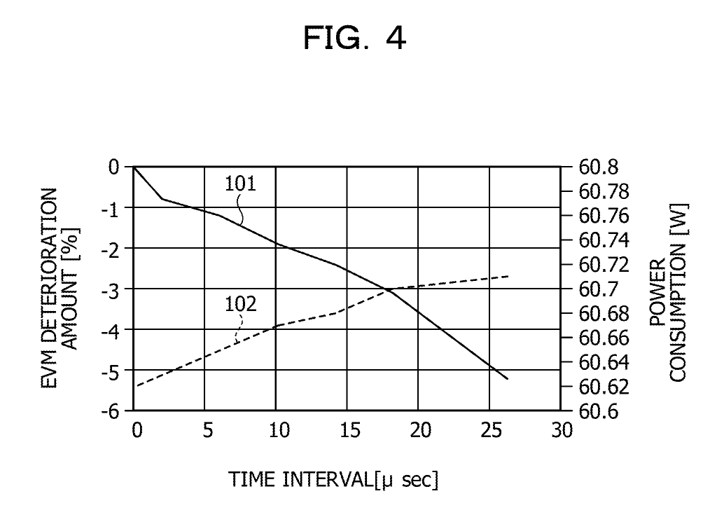

FIG. 4 is a graph illustrating an example of the time interval DB 49a. The time interval DB 49a illustrated in FIG. 4 stores, as a correspondence relation, a graph in which an abscissa is a time interval [μsec] between timing of turning off the transmission circuit 32 and timing of turning off the transmission circuit 33, a first ordinate is an EVM deterioration amount [%], and a second ordinate is power consumption [W]. In FIG. 4, a curve 101 indicates changes in the EVM deterioration amount when a plurality of different time intervals is set for the timing of turning off the transmission circuit 32 and the timing of turning off the transmission circuit 33. Also, a curve 102 indicates changes in the power consumption when a plurality of different time intervals is set for the timing of turning off the transmission circuit 32 and the timing of turning off the transmission circuit 33. The correspondence relation illustrated in FIG. 4 is achieved by actually measuring the EVM deterioration amount and the power consumption when a plurality of different time intervals is set for the timing of turning off the transmission circuit 32 and the timing of turning off the transmission circuit 33, for example, in a prototype of the RE device 30. As understood from FIG. 4, as the time interval between the timing of turning off the transmission circuit 32 and the timing of turning off the transmission circuit 33 increases, the EVM deterioration amount reduces and the power consumption increases.

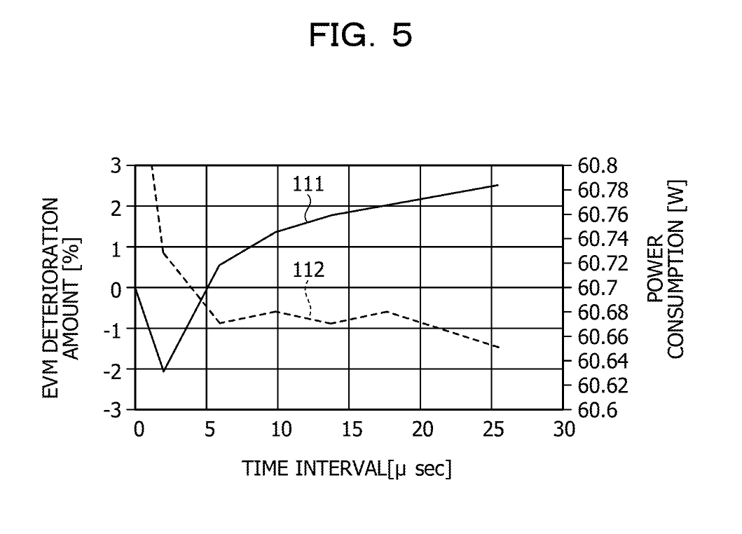

FIG. 5 is a graph illustrating another example of the time interval DB 49a. The time interval DB 49a illustrated in FIG. 5 stores, as a correspondence relation, a graph in which an abscissa is a time interval [μsec] between timing of turning on the transmission circuit 32 and timing of turning on the transmission circuit 33, a first ordinate is the EVM deterioration amount [%], and a second ordinate is the power consumption [W]. In FIG. 5, a curve 111 indicates changes in the EVM deterioration amount when a plurality of different time intervals is set for the timing of turning on the transmission circuit 32 and the timing of turning on the transmission circuit 33. Also, a curve 112 indicates changes in the power consumption when a plurality of different time intervals is set for the timing of turning on the transmission circuit 32 and the timing of turning on the transmission circuit 33. The correspondence relation illustrated in FIG. 5 is achieved by actually measuring the EVM deterioration amount and the power consumption when a plurality of different time intervals is set for the timing of turning on the transmission circuit 32 and the timing of turning on the transmission circuit 33, for example, in a prototype of the RE device 30. As understood from FIG. 5, in a range in which the time interval between the timing of turning on the transmission circuit 32 and the timing of turning on the transmission circuit 33 is about 2 μsec or less, as the time interval increases, both of the EVM deterioration amount and the power consumption reduce. On the other hand, in a range in which the time interval between the timing of turning on the transmission circuit 32 and timing of turning on the transmission circuit 33 exceeds about 2 μsec, as the time interval increases, the EVM deterioration amount increases and the power consumption reduces.

The time interval DB 49b is a database configured to store a time interval between timing of turning on or off the reception circuit 34 and timing of turning on or off the reception circuit 35, the EVM deterioration amount in the reception circuit 34 or the reception circuit 35, and information (which may be referred to as second correspondence relation information) which indicates a correspondence relation between the RE device 30 and the power consumption.

The standard value DB 49c is a database configured to store a plurality of modulation systems and information (which may be referred to as third correspondence relation information) which indicates a correspondence relation with a standard value of EVM, which differs depending on each modulation system.

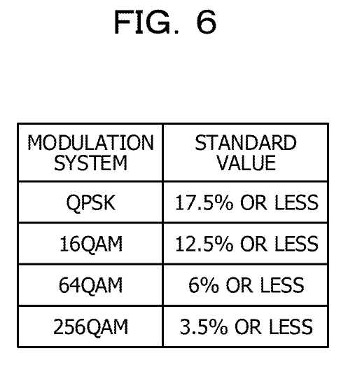

FIG. 6 is a table illustrating an example of the standard value DB 49c. For example, as illustrated in FIG. 6, the standard value DB 49c stores, as a correspondence relation, a table in which a modulation system and a standard value of EVM are associated with one another. The modulation system is a modulation system of a transmission signal (that is, the first transmission signal or the second transmission signal) or a reception signal (that is, the first reception signal or the second reception signal) and, in the standard value DB 49c, QPSK, 16QAM, 64QAM, and 256QAM are stored. As understood from FIG. 6, the standard value of EVM reduces as a modulation multilevel number of the modulation system increases. In other words, a range of the standard value of EVM or less reduces as a modulation multilevel number of the modulation system increases.

The power source control unit 50 calculates a deterioration amount which causes EVM of the transmission signal that has been measured by the EVM measurement unit 47 to be in a range of the standard value or less. The power source control unit 50 refers to the time interval DB 49a of the storage unit 49, specifies a time interval that corresponds to the deterioration amount that has been calculated and causes the power consumption to be minimum, and shifts the timing of turning on or off the transmission circuit 32 from the timing of turning on or off the transmission circuit 33 only by the time interval that has been specified. For example, in a gap section in the TDD system, the power source control unit 50 refers to the time interval DB 49a of the storage unit 49 and shifts the timing of turning on or off the transmission circuit 32. That is, the power source control unit 50 outputs, in a gap section, a switching signal that turns on or off the transmission circuit 33 to the power source switch 44, and then, outputs a switching signal that turns on or off the transmission circuit 32 to the power source switch 43 at a time point at which the time interval that has been specified has elapsed. Note that the gap section in the TDD system is a section in which a signal is not transmitted and received from the antenna A1 and the antenna A2, that is, a section between a transmission section and a reception section.

Also, the power source control unit 50 calculates a deterioration amount that causes EVM of the reception signal that has been measured by the EVM measurement unit 47 to be in the range of the standard value or less. The power source control unit 50 refers to the time interval DB 49b of the storage unit 49, specifies a time interval that corresponds to the deterioration amount that has been calculated and causes the power consumption to be minimum, and shifts the timing of turning on or off the reception circuit 34 from the timing of turning on or off the reception circuit 35 only by the time interval that has been specified. For example, in a gap section in the TDD system, the power source control unit 50 refers to the time interval DB 49b of the storage unit 49 and shifts the timing of turning on or off the reception circuit 34. That is, in the gap section, the power source control unit 50 outputs a switching signal that turns on or off the reception circuit 35 to the power source switch 46, and then, outputs a switching signal that turns on or off the reception circuit 34 to the power source switch 45 at the time point at which the time interval that has been specified has elapsed.

Processing in which the power source control unit 50 calculates the deterioration amount that causes EVM of the transmission signal or the reception signal to be in the range of the standard value or less will be described further in detail below. The power source control unit 50 refers to the standard value DB 49c of the storage unit 49 and selects a standard value of EVM which corresponds to the modulation system of the transmission signal or the reception signal, which has been estimated by the modulation system estimation unit 48. Then, the power source control unit 50 calculates a deterioration amount that causes EVM of the transmission signal or the reception signal, which has been measured by the EVM measurement unit 47, to be in a range of the standard value of EVM, which has been selected, or less. That is, the power source control unit 50 calculates the deterioration value by deducting EVM of the transmission signal or the reception signal, which has been measured, from the standard value of EVM, which has been selected. If a sign of the deterioration amount that has been calculated by the power source control unit 50 is positive, the deterioration amount corresponds to a margin of EVM for the standard value and, if the sign of the deterioration amount that has been calculated by the power source control unit 50 is negative, the deterioration amount corresponds to an amount by which EVM exceeds the standard value.

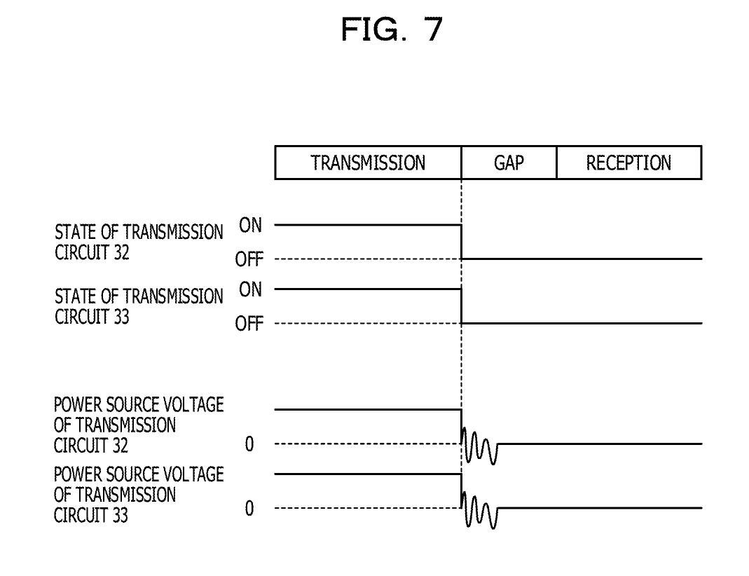

Next, with reference to FIG. 7 to FIG. 10, switching on or off the transmission circuits 32 and 33 by the power source control unit 50 will be described using a specific example.

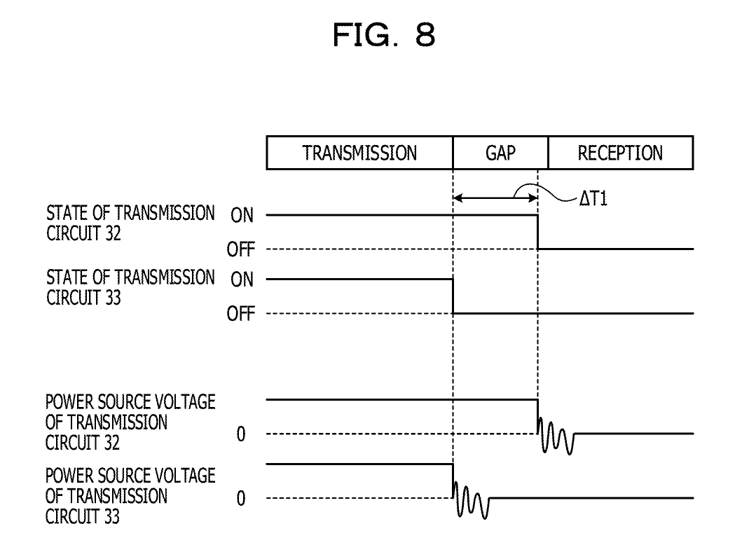

FIG. 7 and FIG. 8 are charts illustrating a first specific example of switching on or off transmission circuits. An uppermost part in each of FIG. 7 and FIG. 8 illustrates an example of timing of transmission and reception of a signal in the TDD system. In this case, it is assumed that a section is switched in the order of a transmission section, a gap section, and a reception section.

First, a case in which the power source control unit 50 does not shift the timing of turning off the transmission circuit 32 is assumed. In this case, as illustrated in FIG. 7, when a transmission section is switched to a gap section, the power source control unit 50 outputs a switching signal that turns off the transmission circuit 32 to the power source switch 43 and outputs a switching signal that turns off the transmission circuit 33 to the power source switch 44. Thus, the transmission circuit 32 and the transmission circuit 33 are switched off at the same time. When the transmission circuit 32 and the transmission circuit 33 are switched off at the same time, each of a power source voltage that is applied to the transmission circuit 32 and a power source voltage that is applied to the transmission circuit 33 transiently changes and eventually converges to 0. However, a range of the transient change in power source voltage of each of the transmission circuits 32 and 33 is relatively large, and therefore, at a time point of an end of the transmission section, EVM in each of the transmission circuits 32 and 33 is deteriorated.

Therefore, in this embodiment, the power source control unit 50 shifts the timing of turning off the transmission circuit 32 from the timing of turning off the transmission circuit 33. That is, as illustrated in FIG. 8, when a transmission section is switched to a gap section, the power source control unit 50 outputs a switching signal that turns off the transmission circuit 33 to the power source switch 44. Then, the power source control unit 50 outputs a switching signal that turns off the transmission circuit 33 to the power source switch 44, and then, at a time point at which a time interval ΔT1 that has been specified using the time interval DB 49a has elapsed, outputs a switching signal that turns off the transmission circuit 32 to the power source switch 43. Thus, from a time point at which the transmission circuit 33 has been switched off to a time point at which the time interval ΔT1 has elapsed, the transmission circuit 32 is switched off. That is, the timing of turning off the transmission circuit 32 is shifted from the timing of turning off the transmission circuit 33 only by the time interval ΔT1. When the timing of turning off the transmission circuit 32 is shifted from the timing of turning off the transmission circuit 33 only by the time interval ΔT1, the range of transient change in power source voltage of each of the transmission circuits 32 and 33 reduces, as compared to the range of change illustrated in FIG. 7. Therefore, at a time point of an end of the transmission section, deterioration in EVM in each of the transmission circuits 32 and 33 is reduced and, as a result, deterioration in transmission quality is reduced.

An example of the above-described time interval ΔT1 will be described below. A case in which EVM of the transmission signal, which has been measured by the EVM measurement unit 47, is 5% and the modulation system of the transmission signal, which has been estimated by the modulation system estimation unit 48, is 256QAM is assumed. In accordance with the standard value DB 49c, a standard value of EVM, which corresponds to 256QAM, is 3.5%, and therefore, a deterioration amount that causes EVM of the transmission signal to be in a range of 3.5% or less may be a value in a range of 3.5−5=−1.5% or less. Then, in accordance with the time interval DB 49a illustrated in FIG. 4, the time interval ΔT1 that corresponds to a deterioration amount of −1.5% or less and causes the power consumption to be minimum is about 7 μsec. Therefore, EVM of the transmission signal may be caused to be in the range of the standard value or less and the power consumption may be caused to be minimum by setting the time interval ΔT1 to about 7 μsec.

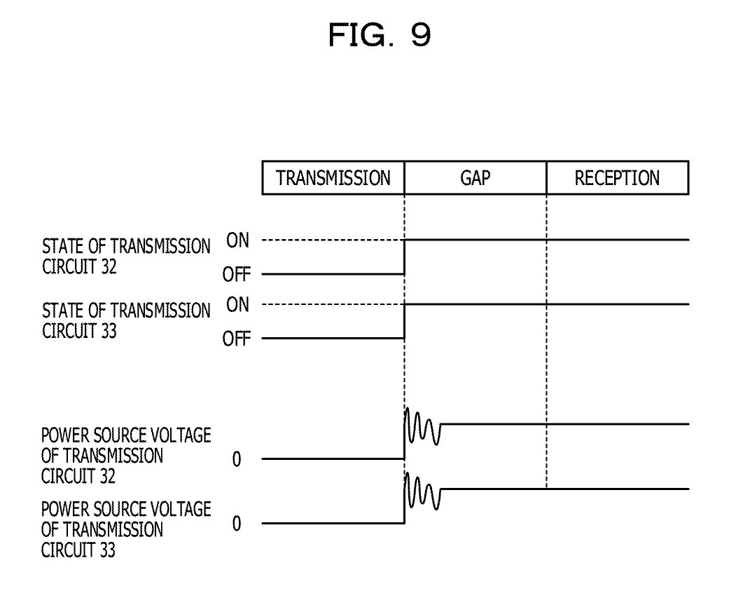

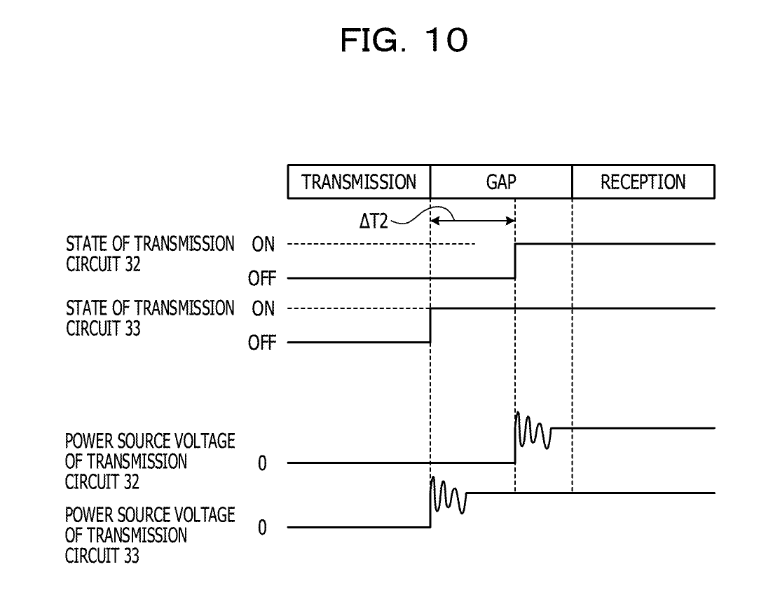

FIG. 9 and FIG. 10 are charts illustrating a second specific example of switching on or off the transmission circuits 32 and 33. An uppermost part in each of FIG. 9 and FIG. 10 illustrates an example of timing of transmission and reception of a signal in the TDD system. In this case, it is assumed that a section is switched in the order of a reception section, a gap section, and a transmission section.

First, a case in which the power source control unit 50 does not shift the timing of turning on the transmission circuit 32 is assumed. In this case, when a reception section is switched to a gap section, the power source control unit 50 outputs a switching signal that turns on the transmission circuit 32 to the power source switch 43 and outputs a switching signal that turns on the transmission circuit 33 to the power source switch 44. Thus, the transmission circuit 32 and the transmission circuit 33 are switched on at the same time. When the transmission circuit 32 and the transmission circuit 33 are switched on at the same time, each of a power source voltage that is applied to the transmission circuit 32 and a power source voltage that is applied to the transmission circuit 33 transiently changes and eventually converges to a predetermined value. However, a range of the transient change in power source voltage of each of the transmission circuits 32 and 33 is relatively large, and therefore, at a time point of a start of the transmission section, EVM in each of the transmission circuits 32 and 33 is deteriorated.

Therefore, in this embodiment, the power source control unit 50 shifts the timing of turning on the transmission circuit 32 from the timing of turning on the transmission circuit 33. That is, as illustrated in FIG. 10, when a reception section is switched to a gap section, the power source control unit 50 outputs a switching signal that turns on the transmission circuit 33 to the power source switch 44. Then, the power source control unit 50 outputs a switching signal that turns on the transmission circuit 33 to the power source switch 44, and then, at a time point at which a time interval ΔT2 that has been specified using the time interval DB 49a has elapsed, outputs a switching signal that turns on the transmission circuit 32 to the power source switch 43. Thus, from a time point at which the transmission circuit 33 has been switched on to a time point at which the time interval ΔT2 has elapsed, the transmission circuit 32 is switched on. That is, the timing of turning on the transmission circuit 32 is shifted from the timing of turning on the transmission circuit 33 only by the time interval ΔT2. When the timing of turning on the transmission circuit 32 is shifted from the timing of turning on the transmission circuit 33 only by the time interval ΔT2, the range of transient change in power source voltage of each of the transmission circuits 32 and 33 reduces, as compared to the range of change illustrated in FIG. 9. Therefore, at a time point of a start of the transmission section, deterioration in EVM in each of the transmission circuits 32 and 33 is reduced and, as a result, deterioration in transmission quality is reduced.

An example of the above-described time interval ΔT2 will be described below. A case in which EVM of the transmission signal, which has been measured by the EVM measurement unit 47, is 5% and the modulation system of the transmission signal, which has been estimated by the modulation system estimation unit 48, is 64QAM is assumed. In accordance with the standard value DB 49c, a standard value of EVM, which corresponds to 64QAM, is 6%, and therefore, a deterioration amount that causes EVM of the transmission signal to be in a range of 6% or less may be a value in a range of 6−5=1% or less. Then, in accordance with the time interval DB 49a illustrated in FIG. 5, the time interval ΔT2 that corresponds to a deterioration amount of 1% or less and causes the power consumption to be minimum is about 6 μsec. Therefore, EVM of the transmission signal may be caused to be in the range of the standard value or less and the power consumption may be set minimum by setting the time interval ΔT2 to about 6 μsec.

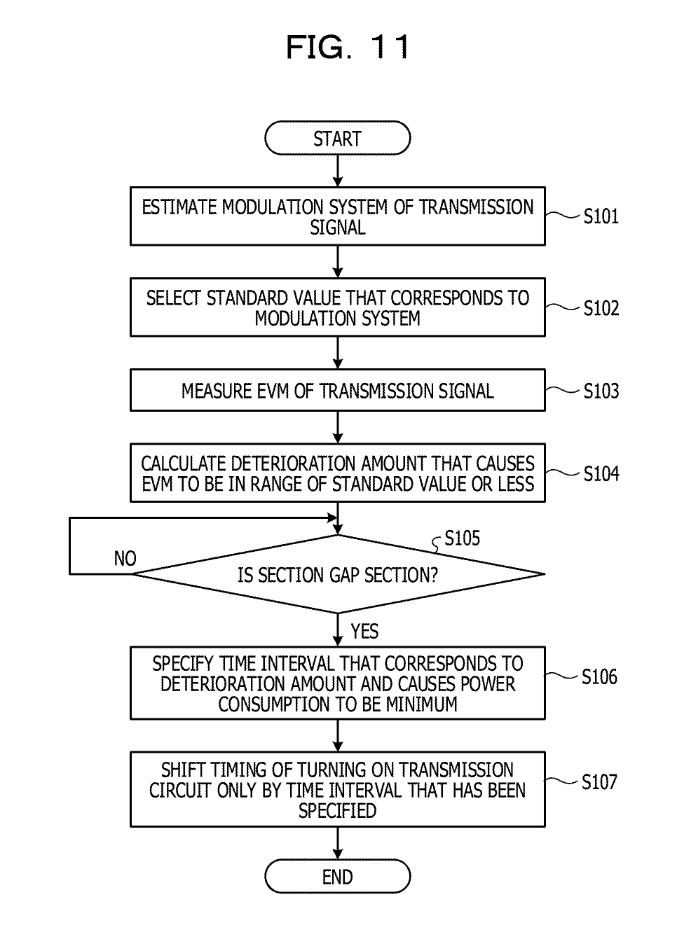

Next, an example of a processing operation of the RE device 30 having the above-described configuration will be described. FIG. 11 is a flowchart illustrating an example of a processing operation of the RE device 30 according to the embodiment. In the example of FIG. 11, a case in which the timing of turning on the transmission circuit 32 is shifted from the timing of turning on the transmission circuit 33 will be described.

In the RE device 30, the modulation system estimation unit 48 estimates a modulation system of a transmission signal that is transmitted from the antenna A1 or the antenna A2 (Step S101).

The power source control unit 50 refers to the standard value DB 49c of the storage unit 49 and selects a standard value of EVM, which corresponds to the modulation system of the transmission signal, which has been estimated (Step S102).

The EVM measurement unit 47 measures EVM of the transmission signal that is transmitted from the antenna A1 or the antenna A2 (Step S103).

The power source control unit 50 calculates a deterioration amount which causes EVM of the transmission signal, which has been measured, to be in a range of the standard value or less (Step S104).

The power source control unit 50 waits for a gap section (Step S105). When a gap section has come (YES in Step S105), the power source control unit 50 refers to the time interval DB 49a of the storage unit 49 and specifies a time interval that corresponds to the deterioration amount that has been calculated and causes the power consumption to be minimum (Step S106). Then, the power source control unit 50 shifts the timing of turning on the transmission circuit 33 only by the time interval that has been specified (Step S107).

As described above, according to this embodiment, a deterioration amount that causes EVM of a transmission signal to be in a range of a standard value or less is calculated. Then, according to this embodiment, with reference to a correspondence relation among a time interval between timings of turning on or off a plurality of transmission circuits and the deterioration amount of EVM and power consumption, timing of turning on or off each transmission circuit is shifted only by a time interval that corresponds to the deterioration amount that has been calculated and causes the power consumption to be minimum. Therefore, EVM of the transmission signal may be caused to be in the range of the standard value or less and the power consumption may be caused to be minimum. As a result, while reducing deterioration in transmission quality, increase in power consumption may be reduced.

Also, according to this embodiment, a deterioration amount that causes EVM of a reception signal to be in a range of a standard value or less is calculated. Then, according to this embodiment, with reference to a time interval between timings of turning on or off a plurality of reception circuits and a correspondence relation between a deterioration amount of EVM and power consumption, timing of turning on or off each reception circuit is shifted only by a time interval that corresponds to the deterioration amount that has been calculated and causes the power consumption to be minimum. Therefore, EVM of the reception signal may be caused to be in the range of the standard value or less and the power consumption may be caused to be minimum. As a result, while reducing deterioration in transmission quality, increase in power consumption may be reduced.

Note that each component element of each unit illustrated in the drawings in this embodiment may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like.

Furthermore, the whole or a part of each processing function performed by each unit may be executed on a central processing unit (CPU) (or a microcomputer, such as a micro processing unit (MPU), a micro controller unit (MCU), or the like). Also, the whole or a part of each processing function may be executed on a program that is analyzed and executed by a CPU (or a microcomputer, such as an MPU, an MCU, or the like) or a hardware of a wired logic.

The RE device 30 according to this embodiment may be realized, for example, by a hardware configuration described below.

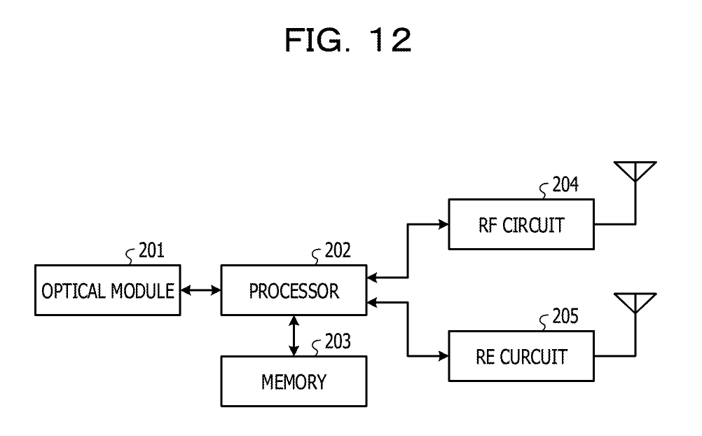

FIG. 12 is a diagram illustrating a hardware configuration example of the RE device 30. As illustrated in FIG. 7, the RE device 30 includes an optical module 201, a processor 202, a memory 203, and RF circuits 204 and 205. Examples of the processor 202 include a CPU, a digital signal processor (DSP), a field programmable gate array (FPGA), or the like. Also, examples of the memory 203 include a random access memory (RAM), such as synchronous dynamic random access memory (SDRAM) or the like, a read only memory (ROM), a flash memory, or the like.

Then, each processing function that is performed by the RE device 30 according to this embodiment may be realized by causing a processor to execute a program that is stored in each of various memories, such as a nonvolatile storage medium or the like. That is, a program that corresponds to each processing that is executed by the EVM measurement unit 47, the modulation system estimation unit 48, and the power source control unit 50 may be recorded in the memory 203 and each program may be executed by the processor 202. Processing of the EVM measurement unit 47 and processing of the power source control unit 50 which are related to a transmission signal may be referred to as first measurement processing and first control processing, respectively. Processing of the EVM measurement unit 47 and processing of the power source control unit 50 which are related to a reception signal may be referred to as second measurement processing and second control processing, respectively. The storage unit 49 is realized by the memory 203. The optical interface circuit 31 is realized by the optical module 201. The transmission circuit 32, the reception circuit 34, the circulator 36, the isolator 38, and the filter 40 are realized by the RF circuit 204. The transmission circuit 33, the reception circuit 35, the circulator 37, the isolator 39, and the filter 41 are realized by the RF circuit 205.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A radio apparatus for a radio communication using a plurality of antennas, the apparatus comprising:
a first transmission circuit configured to output a first transmission signal to be transmitted from a first antenna;
a second transmission circuit configured to output a second transmission signal to be transmitted from a second antenna;
a memory configured to store one or more of first correspondence relation information that indicates a first correspondence relation among a transmission time interval between timing of turning on or off the first transmission circuit and timing of turning on or off the second transmission circuit, a deterioration amount in signal quality value in the first transmission circuit or the second transmission circuit, and power consumption of the radio apparatus; and
a processor configured to
execute first measurement processing that includes measuring a signal quality value of a transmission signal to be transmitted from the first antenna or the second antenna,
execute first control processing that includes
a processing 1-1 configured to calculate a deterioration amount that causes the signal quality value of the transmission signal to be in a range of a standard value or less,
a processing 1-2 configured to specify, in accordance with the one or more of the first correspondence relation information, a first time interval that causes the power consumption to be minimum, the first time interval being one of the transmission time intervals included in the first correspondence relation information that correspond to the deterioration amounts calculated by the processing 1-1, and
a processing 1-3 configured to shift timing of turning on or off the first transmission circuit, in accordance with the first time interval specified by the processing 1-2.

2. The radio apparatus according to claim 1,
wherein the processing 1-3 in the first control processing is executed during a gap section in which a signal is not transmitted or received from the first antenna and the second antenna.

3. The radio apparatus according to claim 1, further comprising:
a first reception circuit configured to execute reception processing for a reception signal to be received from the first antenna; and
a second reception circuit configured to execute reception processing for a reception signal to be received from the second antenna,
wherein the memory is further configured to store second correspondence relation information that indicates a second correspondence relation among a reception time interval between timing of turning on or off the first reception circuit and timing of turning on or off the second reception circuit, a second deterioration amount in a signal quality value in the first reception circuit or the second reception circuit, and power consumption of the radio apparatus, and
the processor is further configured to execute
second measurement processing that includes measuring the signal quality value of the reception signal that is to be received from the first antenna or the second antenna,
second control processing that includes
a processing 2-1 configured to calculate a deterioration amount that causes the signal quality value of the reception signal to be in a range of a standard value or less,
a processing 2-2 configured to specify, in accordance with the one or more of the second correspondence relation information, a second time interval that causes the power consumption to be minimum, the second time interval being one of the reception time intervals included in the second correspondence relation information that correspond to the deterioration amounts that have been calculated, and
a processing 2-3 configured to shift timing of turning on or off the first reception circuit, in accordance with the second time interval specified by the processing 2-2.

4. The radio apparatus according to claim 3,
wherein the processing 2-3 in the second control processing is executed during a gap section in which a signal is not transmitted or received from the first antenna and the second antenna.

5. The radio apparatus according to claim 1,
wherein the processor is further configured to execute estimation processing that includes estimating a modulation system of the transmission signal to be transmitted from the first antenna or the second antenna or the reception signal to be received from the first antenna or the second antenna,
the memory is further configured to store one or more of third correspondence relation information that indicates a third correspondence relation among a plurality of modulation systems and a standard value that differs in accordance with each of the plurality of modulation system,
the first control processing further includes
a processing 3-1 configured to select, in accordance with the third correspondence relation information, a standard value that corresponds to the modulation system estimated by the estimation processing, and
a processing 3-2 configured to calculate a deterioration amount that causes the signal quality value of the transmission signal or the signal quality value of the reception signal to be in a range of the standard value selected by the processing 3-1.

6. A method for timing control that is executed by a radio apparatus that includes a first transmission circuit configured to execute transmission processing of a transmission signal to be transmitted from a first antenna and a second transmission circuit configured to execute transmission processing of a transmission signal to be transmitted from a second antenna, the method comprising:
executing, by a processor of the radio apparatus, first measurement processing that includes measuring a signal quality value of a transmission signal to be transmitted from the first antenna or the second antenna;
executing, by the processor of the radio apparatus, first control processing that includes
a processing 1-1 configured to calculate a deterioration amount that causes the signal quality value of the transmission signal to be in a range of a standard value or less,
a processing 1-2 configured to specify first time interval in accordance with first correspondence relation information, the first correspondence relation information being information that indicates a first correspondence relation among a transmission time interval between timing of turning on or off the first transmission circuit and timing of turning on or off the second transmission circuit, a deterioration amount in signal quality value in the first transmission circuit or the second transmission circuit, and power consumption of the radio apparatus, the first time interval being one of the transmission time intervals included in the first correspondence relation information that correspond to the deterioration amounts calculated by the processing 1-1 and causing the power consumption to be minimum, and
a processing 1-3 configured to shift timing of turning on or off the first transmission circuit, in accordance with the time interval specified by the processing 1-2.
